(19) United States
(12) Patent Application Publication
(10) Pub. No.: US 2003/0090042 A1
(43) Pub. Date: May 15, 2003

(54) Self adjustable variable shape forming plug assist assembly

(76) Inventors: Robert S Sevigny, Athens, TN (US); Mark J Borys, Brighton, MI (US); Roland Mack, Westland, MI (US); Alex J Kaminski, Haslett, MI (US); Brennon White, Commerce, MI (US)

Correspondence Address: Robin W Asher, Clark Hill, Suite 3500, 500 Woodward Avenue, Detroit, MI, 48226-3435, US

(21) Appl. No.: 10/204,071

(22) PCT Filed: Feb. 16, 2001
(86) PCT No.: PCT/CA01/00179

(51) Int. Cl. B29C 51/30

(52) U.S. Cl. 264/554; 425/470; 425/388; 425/394; 264/219

(57) ABSTRACT

A plug assist assembly for positioning a thermo-formable sheet onto one of a plurality of different female molds. The assembly comprises a lifting apparatus and a frame. The frame extends from the lifting apparatus which provides for beneficial movement of the frame. A plurality of movable weights are suspended from the frame for contacting and automatically conforming to a contour of any of the female molds. The plurality of weights create a seal between the sheet and the female mold to allow the sheet to be vacuum formed against the mold.

### BACKGROUND OF THE INVENTION

1. Field of the Invention

The subject invention relates to a variable shape forming plug assist assembly for a vacuum molding process.

2. Description of the Related Art

During the manufacture of molded components, a mold assembly is typically utilized comprising a male mold, or forming plug and a female mold. Each female mold is specifically contoured in a desired shape which is to be the shape of the molded component. A material, such as a vinyl sheet, is placed upon the female mold which will become the component itself. A corresponding male plug is provided and placed on the female mold to retain and create a seal between the female mold and the material. A vacuum is then commonly applied to the female mold. The material is then pulled against the female mold and the component is created, or vacuum formed.

Many manufacturing process for forming molded component utilize moving carousels which incorporate a plurality of the same female molds with a single male plug. The male plugs are not interchangeable with the different female molds. This dependency limits the production of a manufacturing line because the line can only build the particular component with which the female mold is associate or desired to form. Also, a line may be running at half capacity depending on the need for the component.

Hence, it would be advantageous to create a male plug which is interchangeable with many different female molds such that a plurality of varying female molds could be placed on the same carousel or manufacturing line for engagement with the same male plug. This would also allow all the lines to operate at full capacity which saves capital costs of operating lines at less than full capacity.

### SUMMARY OF THE INVENTION

The subject invention relates to a plug assist assembly for positioning a thermo-formable sheet onto a plurality of contoured female molds. The assembly comprises a lifting apparatus and a frame extending from the lifting apparatus. The lifting apparatus is operable for providing selective movement of the frame relative to the female molds. A plurality of movable weights are suspended from the frame for contacting and automatically conforming to the contour of any of the female molds to seal the sheet there against.

The subject invention allows many differently orientated, or contoured, female molds to be placed on a single production line with the plug assist assembly. The plug assist assembly sufficiently seals to the female molds, which allows for the production line to operate at full capacity.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective side view of a plug assist assembly in accordance with a preferred embodiment of the subject invention;

FIG. 2 is a side view of the plug assist assembly contacting a female mold; and

FIG. 3 is a perspective side view of an alternative embodiment of the plug assist assembly.

### DETAILED DESCRIPTION OF THE PREFERRED EMBODIMENTS

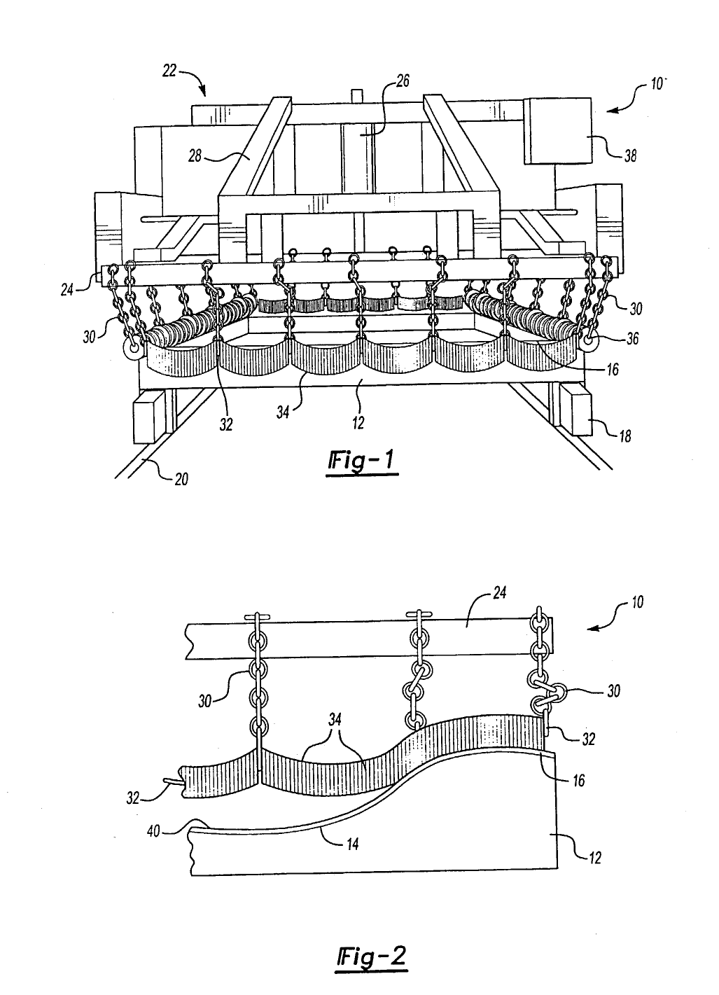

Referring to the Figures, wherein like numerals indicate like or corresponding parts throughout the several views, a variable shape forming plug assist assembly is generally shown at 10 in FIG. 1.

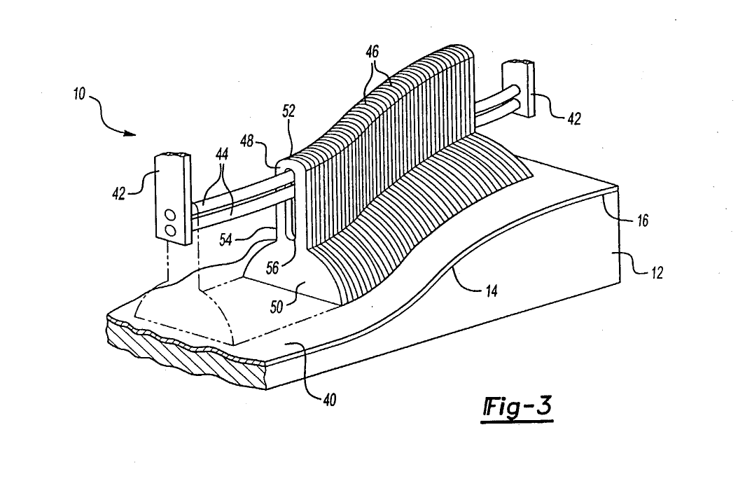

The plug assist assembly 10 is designed to operate with any one of a plurality of different shaped female vacuum molds 12. Each female mold 12 includes an upper mold surface 14, as shown in FIG. 2, having a particular contour which defines the final shape of a component to be formed, such as a contoured headliner or door panel of an automotive vehicle. The female mold 12 further includes an outer peripheral rim 16 and is supported by a support frame 18. The support frame 18 may be interchangably mounted to a movable assembly line or carousel 20 for movement into association with the plug assist assembly 10.

The plug assist assembly 10 includes a lifting apparatus 22 and a frame 24. The lifting apparatus 22 shown includes a pneumatic or hydraulic cylinder 26 affixed to a plurality of structural members defining a lift cage 28 for positioning the frame 24 above the female mold 12. Preferably, the frame 24 extends around the perimeter of the lifting apparatus 22 and is fixedly secured and supported by the lift cage 28. The frame 16 is constructed to support a plurality of chains 30; or other supports members such as cables, rods, wire, ropes or the like, connected by any known means to the frame 24. As should be appreciated, the frame 24 may be of any desired shape and size, suitable to support the proposed or desired load and associate with the female molds 12.

The chains 30 are linked together by an elongated cable 32, or series of cables, which support and suspend a series of geometrically shaped weights 34 from the frame 24. The weights 34 are preferably circular discs of steel, but could be any shape or material. Each of the weights 34 have a centrally located hole 36 which allows the cable 32 to string the weights 34 together and be suspended there from. That is, the weights 34 are positioned closely together in a side-by-side relationship and the cable 32 between each of the chains 30. The cable 32 may be any material, such as rope or wire, that sufficiently supports the weights 34 and is fastened to the chains 30 by any known means. The weights 30 are placed closely together on the cable 32 such that the weights 30 remain substantially vertical. Optionally, an additional matrix of weights could be provided and positioned across the interior of the frame 18, as opposed to along the perimeter as shown. The additional matrix of weights could be suspended from the frame 18 by additional chains or a positioning arm.

The plug assist assembly 10 further includes a programmable controller 38 for actuating the cylinder 26 and position the lifting apparatus 22 and frame 24 relative to the female molds 12. It should be appreciated that the plug assist assembly 10 may also be manual controlled rather than automatically controlled by the controller 38.

Referring to FIG. 2, during the manufacturing of the component, a hot thermo-formable skin 40 is placed over the upper mold surface 14 of the female vacuum mold 12. The skin 40 may include a sheet or layer of material such plastic, leather, vinyl, urethane, or the like. The female molds 12 may be positioned underneath the plug assist assembly 10 by movement of the assembly line or carousel 20. The assembly 10 is then lowered toward the female mold 12 positioned therebeneath and the weights 34 contact the skin 40 about the peripheral rim 16 of the mold 12. The chains 30 collapse, or shorten with slack, to allow the weights 34 to freely move and automatically conform to the contour of the mold surface 14. The lifting apparatus 22 is programmed to lower the frame 24 a predetermined amount for each of the different types of female molds 12 by the controller 38. As the weights 34 contact the skin 40 and mold 12, the weights 34 exert a force on the skin 40 and create a seal between the skin 40 and the mold 12. The force of the weights 34 is proportional to their mass and the area of contact. If a larger force is required for a particular mold, heavier weights or weights with a larger contact area could be used. The plurality of weights 34 follows the varying contours of the mold 12 and mold surface 14. A vacuum is then applied through the mold 12 and to the upper mold surface 14 which pulls the skin 40 into the female mold 12 to shape the skin 40 to the contours of the upper mold surface 14. The lifting apparatus 22 then raises the frame 18 and the molded component formed from the skin 40 is removed from the mold 12.

A second embodiment of the plug assist assembly is shown at 10 in FIG. 3 which uses a plurality of spaced apart support bars 42 fastened to the frame 24. The support bars 42 are connected together by a pair of elongated rods 44 which support a series of weights 46 between opposite spaced apart support bars 42. The weights 46 are stacked close together along the length of the rods 44 and the rods 44 may be positioned by the support bars 42 along the outer peripheral rim 16 of the mold 12 or along the entire contoured mold surface 14. Again, the weights 46 can be of any geometrical shape but preferably have a handle portion 48 and a contact portion 50. The contact portion 50 preferably is wider than the handle portion 48 to provide greater surface contact on the mold 12. The handle portion 48 extends generally vertically between a first distal end 52 and second lower end 54 attached to the contact portion 50. The handle portion 48 has an elongated slot 56 extending between the first end 52 and second end 54 for slidably receiving the rods 44 therethrough to allow up and down, or generally vertical, movement along the rods 44.

In operation, the hot thermo-formable skin 40 is placed over the upper mold surface 14 of the female vacuum mold 12. The female molds 12 are positioned underneath the plug assist assembly 10 by movement of the assembly line or carousel 20. The assembly 10 is then lowered toward the female mold 12 positioned therebeneath and the contact portion 50 of the weights 46 contact the skin 40 about the peripheral rim 16 of the mold 12. The slots 56 in each of the handle portions 48 of the weights 46 allow each of the weights to independently and freely slide up or down on the rods 44 and conform to the contour of the mold surface 14. The lifting apparatus 22 is programmed to lower the frame 24 a predetermined amount for each of the different types of female molds 12 by the controller 38. As the contact portions 50 contact the skin 40 and mold 12, the weights 46 exert a force on the skin 40 and create a seal between the skin 40 and the mold 12. The plurality of weights 34 follows the contour of the mold 12 and mold surface 14. A vacuum is then applied through the mold 12 and to the upper mold surface 14 which pulls the skin 40 into the female mold 12 to shape the skin 40 to the contours of the upper mold surface 14. The lifting apparatus 22 then raises the frame 18 and the molded component formed from the skin 40 is removed from the mold 12.

As illustrated and described, the subject invention creates an interchangeable, or adjustable, plug which may be used with a plurality of different contoured female molds during the manufacturing of various components.

The invention has been described in an illustrative manner, and it is to be understood that the terminology which has been used is intended to be in the nature of words of description rather than of limitation. It is now apparent to those skilled in the art that many modifications and variations of the present invention are possible in light of the above teachings. It is, therefore, to be understood that the invention may be practiced otherwise than as specifically described.

What is claimed is:

1. A plug assist assembly for positioning a thermo-formable sheet onto a plurality of contoured female molds, said assembly comprising:
a lifting apparatus;
a frame extending from said lifting apparatus, said lifting apparatus operable for providing selective movement of said frame relative to the female molds; and
a plurality of movable weights suspended from said frame for contacting and automatically conforming to the contour of any of the female molds to seal the sheet there against.

2. A plug assist assembly as set forth in claim 1 further including a collapsible support member secured to said frame for supporting said plurality of weights for allowing said weights to independently move upon contact with the female mold to automatically conform to the contour of the molds.

3. A plug assist assembly as set forth in claim 2 wherein said collapsible support member includes a plurality of chains suspended from said frame.

4. A plug assist assembly as set forth in claim 3 wherein said collapsible support member includes at least one cable coupled between each of said chains for supporting said a plurality of said weights between each of said chains.

5. A plug assist assembly as set forth in claim 4 wherein said lifting apparatus includes a lift cage for supporting said frame and a cylinder coupled to said lift cage for moving said frame relative to the female mold.

6. A plug assist assembly as set forth in claim 5 further including a programmable controller coupled to said lifting apparatus for selectively controlling movement of said lifting apparatus for any of the female molds.

7. A plug assist assembly as set forth in claim 1 further including at least one elongated rod suspended by said frame for slidably supporting said weights.

8. A plug assist assembly as set forth in claim 7 wherein each of said weights includes a handle portion slidably coupled to said rod and a contact portion extending from said handle portion and adapted to contact the mold.

9. A plug assist assembly as set forth in claim 8 wherein said handle portion includes an elongated slot for slidably mounting said weight to said rod for allowing said weights to independently move along said rod upon contact with the female mold to automatically conform to the contour of the molds.

10. A plug assist assembly as set forth in claim 9 further including a plurality of support bars for attaching said elongated rod to said frame with said plurality of weights slidably suspended therebetween.

11. A plug assist assembly as set forth in claim 10 wherein said lifting apparatus includes a lift cage for supporting said frame and a cylinder coupled to said lift cage for moving said frame relative to the female mold.

12. A plug assist assembly as set forth in claim 11 further including a programmable controller coupled to said lifting apparatus for selectively controlling movement of said lifting apparatus for any of the female molds.

13. A method of forming a mold component comprising:
positioning a thermo-formable sheet onto a contoured mold surface of a female mold;
positioning the female mold adjacent to a plug assist assembly having a lifting apparatus and a frame extending from the lifting apparatus supporting a plurality of weights;
operably controlling movement of the lifting apparatus to position the weights in contact with the sheet and mold; and
automatically conforming the weights to the contour of the mold to create a seal between the sheet and the mold.

14. A method as set forth in claim 13 farther including applying a vacuum to the mold to form the sheet against the contour of the mold.

15. A method a set forth in claim 14 further including moving the lifting apparatus to lift the weights from the mold and removing the vacuum formed sheet from the mold.
